(19) United States
(12) Patent Application Publication
(10) Pub. No.: US 2024/0303526 A1
(43) Pub. Date: Sep. 12, 2024

(54) Quantum Error Correction Decoding Incorporating Assisted Machine Learning

(71) Applicant: Equal 1 Laboratories Ireland Limited, Dublin 4 (IE)

(72) Inventor: David J. Redmond, Cork (IE)

(21) Appl. No.: 18/599,492

(22) Filed: Mar. 8, 2024

Related U.S. Application Data
(60) Provisional application No. 63/450,984, filed on Mar. 9, 2023.

(51) Int. Cl. G06N 10/70; G06N 3/08

(52) U.S. Cl. CPC G06N 10/70; G06N 3/08

(57) ABSTRACT

A novel and useful mechanism for iterative quantum error correction using multiple orthogonal low level decoders with machine learning assist to optimize decoder solutions for finding the optimal solution in real time for a fault tolerant quantum system. A machine learning algorithm is employed to find the optimal decoder solution to correct detected error(s) while preserving the logical state of the quantum system. The QEC mechanism addresses the disadvantages of the prior art by providing multiple error correction solutions and leveraging machine learning (ML) techniques to choose the best one to avoid the introduction of the logical error conditions and greatly increase the coverage for error correction within the system.

### REFERENCE TO PRIORITY APPLICATION

This application claims the benefit of U.S. Provisional Application No. 63/450,984, filed Mar. 9, 2023, entitled “Quantum Error Correction Decoding Incorporating Assisted Machine Learning,” incorporated herein by reference in its entirety.

### FIELD OF THE DISCLOSURE

The subject matter disclosed herein relates to the field of quantum computing and more particularly relates to a quantum error decoding technique using assisted machine learning.

### BACKGROUND OF THE INVENTION

Quantum computing is a new paradigm that exploits fundamental principles of quantum mechanics, such as superposition and entanglement, to tackle problems in mathematics, chemistry and material science that are well beyond the reach of supercomputers. Quantum computing systems hold promise for revolutionizing various fields due to their potential to perform complex calculations at unprecedented speeds. Its power is derived from a quantum bit (qubit), which can simultaneously exist as a superposition of both 0 and 1 states and can become entangled with other qubits. This leads to doubling the computational power with each additional qubit, which can be repeated many times. It has been already shown that quantum computers can speed up some of the algorithms and, potentially, model any physical process.

Quantum computers are machines that perform computations using the quantum effects between elementary particles, e.g., electrons, holes, ions, photons, atoms, molecules, etc. Quantum computing utilizes quantum-mechanical phenomena such as superposition and entanglement to perform computation. Quantum computing is fundamentally linked to the superposition and entanglement effects and the processing of the resulting entanglement states. A quantum computer is used to perform such computations which can be implemented theoretically or physically.

Currently, analog and digital are the two main approaches to physically implementing a quantum computer. Analog approaches are further divided into quantum simulation, quantum annealing, and adiabatic quantum computation. Digital quantum computers use quantum logic gates to do computation. Both approaches use quantum bits referred to as qubits.

Qubits are fundamental to quantum computing and are somewhat analogous to bits in a classical computer. Qubits can be in a |0> or |1> quantum state but they can also be in a superposition of the |0> and |1> states. When qubits are measured, however, they always yield a |0> or a |1> based on the quantum state they were in.

The key challenge of quantum computing is isolating such microscopic particles, loading them with the desired information, letting them interact and then preserving the result of their quantum interaction. This requires relatively good isolation from the outside world and a large suppression of the noise generated by the particle itself. Therefore, quantum structures and computers operate at very low temperatures (e.g., cryogenic), close to the absolute zero kelvin (K), in order to reduce the thermal energy/movement of the particles to well below the energy/movement coming from their desired interaction. Current physical quantum computers, however, are very noisy and quantum error correction (QEC) is commonly applied to compensate for the noise.

Despite the potential of quantum computing, one of the key challenges is the susceptibility of quantum information to errors caused by environmental factors and imperfections in hardware components. In addition, prior art quantum computers apply quantum error correction that requires relatively long post processing times. Therefore, there is a need for robust error detection and correction mechanisms to ensure reliable operation of quantum computing systems. Preferably, the fault tolerant quantum system does not require lengthy post processing of measurement data. In addition, the QEC solution should be able to generate corrections to errors in the qubit array in real time or near real time.

### SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present invention provides a mechanism for iterative quantum error correction using orthogonal low level decoders with machine learning assist to optimize decoder solutions for finding the optimal solution in real time for a fault tolerant quantum system. A machine learning algorithm is employed to find the optimal decoder solution to correct detected error(s) while preserving the logical state of the quantum system.

Low level decoders (LLDs) themselves, however, may introduce errors into the system. A neural network used to predict these errors may still not prevent an error being introduced into a correction step. The mechanism of the present invention uses successive re-engineered decoders where the neural network decides which LLD provides the best solution. This greatly increases the coverage for error correction within the system. This becomes more significant when the surface code used contains a large number of qubits and there are numerous possible LLD solutions most of which will introduce logical errors.

The QEC mechanism of the present invention addresses the disadvantages of the prior art by providing multiple error correction solutions and leveraging machine learning (ML) techniques to choose the best error correction solution to avoid the introduction of logical error conditions.

The error correction process begins with the detection of errors using ancilla qubits. Syndromes obtained from ancilla measurements are analyzed to identify errors in the qubit array. Subsequently, a decoding strategy is selected based on machine learning predictions to correct the detected errors. The decoding strategy may involve the use of low-level decoders and additional decoders designed to address specific error scenarios. The mechanism uses an iterative or successive approach to find an optimal decoder solution. A neural network is used to identify the best ‘error free’ decoder solution.

By leveraging machine learning techniques, the proposed approach enhances the accuracy and efficiency of error correction processes, thereby overcoming the limitations of conventional error correction mechanisms. The method involves training a neural network to predict errors and select optimal decoding strategies, thereby reducing logical errors and enhancing overall system performance. Furthermore, the present invention addresses the challenge of performing error correction within the decoherence time of qubits, ensuring real-time correction without compromising system integrity. The integration of error correction mechanisms directly into the quantum processing unit (QPU) facilitates seamless operation and maximizes error correction efficiency.

Advantages of the present invention include improved error correction efficiency for a real time quantum error correction system as well as higher accuracy for logical error correction. This partially removes the need for external post processing to correct logical errors.

This, additional, and/or other aspects and/or advantages of the embodiments of the present invention are set forth in the detailed description which follows; possibly inferable from the detailed description; and/or learnable by practice of the embodiments of the present invention.

There is thus provided in accordance with the invention, a method of error detection and correction in a quantum computing system, the method comprising providing a qubit array having an encoding arrangement and a plurality of ancilla bits, extracting a plurality of syndrome codes from said plurality of ancilla bits, providing a plurality of low level decoders that operate in parallel on said plurality of syndrome codes, and utilizing a neural network to predict which of said plurality of low level decoders to use to minimize introducing logical errors in said qubit array.

There is also provided in accordance with the invention, a method for error detection and correction in a quantum computing system, the method comprising receiving a plurality of syndromes from a qubit array having ancilla qubits, analyzing via a plurality of decoders said plurality of syndromes obtained from ancilla measurements to identify errors and propose corrections whereby each decoder independently and in parallel utilizes a different decoding strategy to propose respective qubit corrections, selecting a decoding strategy based on machine learning predictions, and correcting detected errors using the selected decoding strategy.

There is further provided in accordance with the invention, a system for error detection and correction in a quantum computing system, comprising a quantum processing unit (QPU) comprising a two-dimensional encoding arrangement qubit array, a plurality of ancilla qubits for generating syndrome codes, a plurality of low level decoders operating in parallel on said syndrome codes to generate candidate qubit error correction vectors, a neural network trained to predict qubit errors and an optimal decoding strategy based on syndromes obtained from ancilla measurements, and a selector operative to choose one of said candidate qubit error correction vectors based on said optimal decoding strategy.

### BRIEF DESCRIPTION OF THE DRAWINGS

The present invention is explained in further detail in the following exemplary embodiments and with reference to the figures, where identical or similar elements may be partly indicated by the same or similar reference numerals, and the features of various exemplary embodiments being combinable. The invention is herein described, by way of example only, with reference to the accompanying drawings, wherein:

FIG. 1 is a high level block diagram illustrating an example quantum computer system constructed in accordance with the present invention;

FIG. 2 is a diagram illustrating an example quantum core incorporating one or more quantum circuits;

FIGS. 3A and 3B are a diagram illustrating an example machine learning assisted quantum error correction circuit with multiple decoders;

FIGS. 4A and 4B are a diagram illustrating an example machine learning assisted quantum error correction circuit with multiple decoders during training; and

FIG. 5 is a flow diagram illustrating an example decoder method.

### DETAILED DESCRIPTION

In the following detailed description, numerous specific details are set forth in order to provide a thorough understanding of the invention. It will be understood by those skilled in the art, however, that the present invention may be practiced without these specific details. In other instances, well-known methods, procedures, and components have not been described in detail so as not to obscure the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary, for the understanding and appreciation of the underlying concepts of the present invention and in order not to obfuscate or distract from the teachings of the present invention.

Any reference in the specification to a method should be applied mutatis mutandis to a system capable of executing the method. Any reference in the specification to a system should be applied mutatis mutandis to a method that may be executed by the system.

Throughout the specification and claims, the following terms take the meanings explicitly associated herein, unless the context clearly dictates otherwise. The phrases “in one embodiment,” “in an example embodiment,” and “in some embodiments” as used herein do not necessarily refer to the same embodiment(s), though it may. Furthermore, the phrases “in another embodiment,” “in an alternative embodiment,” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following definitions apply throughout this document.

A quantum particle is defined as any atomic or subatomic particle suitable for use in achieving the controllable quantum effect. Examples include electrons, holes, ions, photons, atoms, molecules, artificial atoms. A carrier is defined as an electron or a hole in the case of semiconductor electrostatic qubit. Note that a particle's waveform may be split and be present in multiple quantum dots. Thus, a reference to a particle also includes split particles.

In quantum computing, the qubit is the basic unit of quantum information, i.e. the quantum version of the classical binary bit physically realized with a two-state device. A qubit is a two state quantum mechanical system in which the states can be in a superposition. Examples include (1) the spin of the particle (e.g., electron, hole) in which the two levels can be taken as spin up and spin down; (2) the polarization of a single photon in which the two states can be taken to be the vertical polarization and the horizontal polarization; and (3) the position of the particle (e.g., electron) in a structure of two qdots, in which the two states correspond to the particle being in one qdot or the other. In a classical system, a bit is in either one state or the other. Quantum mechanics, however, allows the qubit to be in a coherent superposition of both states simultaneously, a property fundamental to quantum mechanics and quantum computing. Multiple qubits can be further entangled with each other.

A quantum dot or qdot (also referred to in literature as QD) is a nanometer-scale structure where the addition or removal of a particle changes its properties is some ways. In one embodiment, quantum dots are constructed in silicon semiconductor material having typical dimension in nanometers. The position of a particle in a qdot can attain several states. Qdots are used to form qubits and qudits where multiple qubits or qudits are used as a basis to implement quantum processors and computers. Note that a quantum dot also refers to a quantum well.

A quantum interaction gate is defined as a basic quantum logic circuit operating on a small number of qubits or qudits. They are the building blocks of quantum circuits, just like the classical logic gates are for conventional digital circuits.

A qubit or quantum bit is defined as a two state (two level) quantum structure and is the basic unit of quantum information. A qudit is defined as a d-state (d-level) quantum structure. A qubyte is a collection of eight qubits.

The terms control gate and control terminal are intended to refer to the semiconductor structure fabricated over a continuous well with a local depleted region and which divides the well into two or more qdots. These terms are not to be confused with quantum gates or classical FET gates.

Unlike most classical logic gates, quantum logic gates are reversible. It is possible, however, although cumbersome in practice, to perform classical computing using only reversible gates. For example, the reversible Toffoli gate can implement all Boolean functions, often at the cost of having to use ancillary bits. The Toffoli gate has a direct quantum equivalent, demonstrating that quantum circuits can perform all operations performed by classical circuits.

A quantum well is defined as a very small (e.g., typically nanometer scale) two dimensional area of metal or semiconductor that functions to contain a single or a small number of quantum particles. It differs from a classic semiconductor well which might not attempt to contain a small number of particles or/and preserve their quantum properties. One purpose of the quantum well is to realize a function of a qubit or qudit. It attempts to approximate a quantum dot, which is a mathematical zero-dimensional construct. The quantum well can be realized as a low doped or undoped continuous depleted semiconductor well partitioned into smaller quantum wells by means of control gates. The quantum well may or may not have contacts and metal on top. A quantum well holds one free carrier at a time or at most a few carriers that can exhibit single carrier behavior.

A classic well is a medium or high doped semiconductor well contacted with metal layers to other devices and usually has a large number of free carriers that behave in a collective way, sometimes denoted as a “sea of electrons.”

A quantum structure or circuit is a plurality of quantum interaction gates. A quantum computing core is a plurality of quantum structures. A quantum computer is a circuit having one or more computing cores. A quantum fabric is a collection of quantum structures, circuits, or interaction gates arranged in a grid like matrix where any desired signal path can be configured by appropriate configuration of access control gates placed in access paths between qdots and structures that make up the fabric.

In one embodiment, qdots are fabricated in low doped or undoped continuous depleted semiconductor wells. Note that the term ‘continuous’ as used herein is intended to mean a single fabricated well (even though there could be structures on top of them, such as gates, that modulate the local well's behavior) as well as a plurality of abutting contiguous wells fabricated separately or together, and in some cases might apparently look as somewhat discontinuous when ‘drawn’ using a computer aided design (CAD) layout tool.

The term classic or conventional circuitry (as opposed to quantum structures or circuits) is intended to denote conventional semiconductor circuitry used to fabricate transistors (e.g., FET, CMOS, BJT, FinFET, etc.) and integrated circuits using processes well-known in the art.

The term Rabi oscillation is intended to denote the cyclic behavior of a quantum system either with or without the presence of an oscillatory driving field. The cyclic behavior of a quantum system without the presence of an oscillatory driving field is also referred to as occupancy oscillation.

The state of the quantum system is completely described by the wavefunction y, which for a qubit can be described as a vector on a Bloch sphere. For a multi-state system, the Hilbert space, which is a unitary state, can be used to represent it. Throughout this document, a representation of the state of the quantum system in spherical coordinates of Bloch sphere includes two angles q and j. The state vector Y in spherical coordinates can be described by these two angles. The angle q is between the vector Y and the z-axis and the angle j is the angle between the projection of the vector on the XY plane and the x-axis. Thus, any position on the sphere is described by these two angles q and j. Note that for one qubit Y representation is in three dimensions. For multiple qubits Y representation is in higher order dimensions.

A plunger gate is defined as a gate that functions to change the chemical potential of a quantum dot. A blind contact is a particular implementation of a plunger gate fabricated in one of the metal layers of the process.

### Quantum Computing System

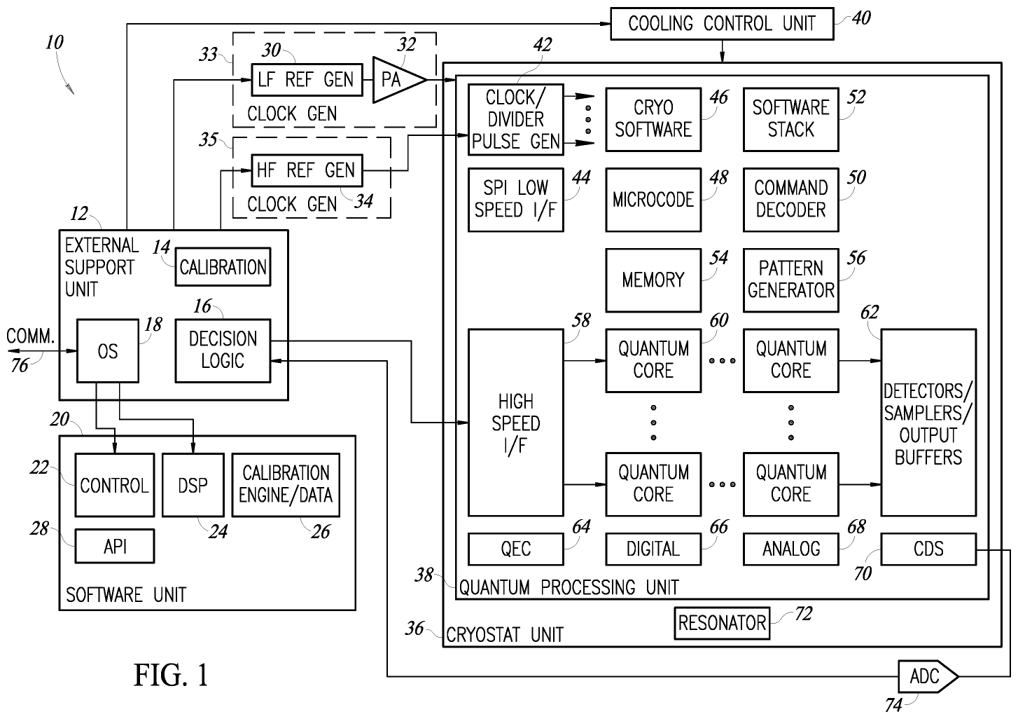

A high level block diagram illustrating an example quantum computer system constructed in accordance with the present invention is shown in FIG. 1. The quantum computer, generally referenced 10, comprises a conventional (i.e. not a quantum circuit) external support unit 12, software unit 20, cryostat unit 36, quantum system 38, clock generation units 33, 35, and one or more communication busses between the blocks. The external support unit 12 comprises operating system (OS) 18 coupled to communication network 76 such as LAN, WAN, PAN, etc., decision logic 16, and calibration block 14. Software unit 20 comprises control block 22 and digital signal processor (DSP) 24 blocks in communication with the OS 18, calibration engine/data block 26, and application programming interface (API) 28.

Quantum system 38 comprises a plurality of quantum core circuits 60, high speed interface 58, detectors/samplers/output buffers 62, quantum error correction (QEC) 64, digital block 66, analog block 68, correlated data sampler (CDS) 70 coupled to one or more analog to digital converters (ADCs) 74 as well as one or more digital to analog converters (DACs, not shown), clock/divider/pulse generator circuit 42 coupled to the output of clock generator 35 which comprises high frequency (HF) generator 34. The quantum system 38 further comprises serial peripheral interface (SPI) low speed interface 44, cryostat software block 46, microcode 48, command decoder 50, software stack 52, memory 54, and pattern generator 56. The quantum system 38 can be used to implement the neural network training accelerator of the present invention. The clock generator 33 comprises low frequency (LF) generator 30 and power amplifier (PA) 32, the output of which is input to the quantum system 38. Clock generator 33 also functions to aid in controlling the spin of the quantum particles in the quantum cores 60.

The cryostat unit 36 is the mechanical system that cools the quantum system down to cryogenic temperatures. The deep cryogenic temperatures also help to speed up the digital and mixed-signal circuits while reducing their dynamic and static power (lower leakage). Typically, it is made from metal and it can be fashioned to function as a cavity resonator 72. It is controlled by cooling unit control 40 via the external support unit 12. The cooling unit control 40 functions to set and regulate the temperature of the cryostat unit 36. By configuring the metal cavity appropriately, it can be made to resonate at a desired frequency. A clock is then driven via a power amplifier which is used to drive the resonator which creates a magnetic field. This magnetic field can function as an auxiliary magnetic field to aid in controlling one or more quantum structures in the quantum core.

The external support unit/software units may comprise any suitable computing device or platform such as an FPGA/SoC board. In one embodiment, it comprises one or more general purpose CPU cores and optionally one or more special purpose cores (e.g., DSP core, floating point, etc.) that interact with the software stack that drives the hardware, i.e. the QPU. The one or more general purpose cores execute general purpose opcodes while the special purpose cores execute functions specific to their purpose. Main memory comprises dynamic random access memory (DRAM) or extended data out (EDO) memory, or other types of memory such as ROM, static RAM, flash, and non-volatile static random access memory (NVSRAM), bubble memory, etc. The OS may comprise any suitable OS capable of running on the external support unit and software units, e.g., Windows, MacOS, Linux, QNX, NetBSD, etc. The software stack includes the API, the calibration and management of the data, and all the necessary controls to operate the external support unit itself. In one embodiment, the external support unit/software units are adapted to implement the mapping and detection in the classic helper neural networks as described in more detail infra.

The clock generated by the high frequency clock generator 35 is input to the clock divider 42 that functions to generate the signals that drive the quantum system. Low frequency clock signals are also input to and used by the QPU. A slow serial/parallel interface (SPI) 44 functions to handle the control signals to configure the quantum operation in the quantum system. The high speed interface 58 is used to pump data from the classic computer, i.e. the external support unit, to the quantum system. The data that the quantum system operates on is provided by the external support unit.

Non-volatile memory may include various removable/non-removable, volatile/nonvolatile computer storage media, such as hard disk drives that reads from or writes to non-removable, nonvolatile magnetic media, a magnetic disk drive that reads from or writes to a removable, nonvolatile magnetic disk, an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The computer may operate in a networked environment via connections to one or more remote computers. The remote computer may comprise a personal computer (PC), server, router, network PC, peer device or other common network node, or another quantum computer, and typically includes many or all of the elements described supra. Such networking environments are commonplace in offices, enterprise-wide computer networks, intranets and the Internet.

When used in a LAN networking environment, the computer is connected to the LAN via network interface 76. When used in a WAN networking environment, the computer includes a modem or other means for establishing communications over the WAN, such as the Internet. The modem, which may be internal or external, is connected to the system bus via user input interface, or other appropriate mechanism.

Computer program code for carrying out operations of the present invention may be written in any combination of one or more programming languages, including an object oriented programming language such as Java, Smalltalk, C++, C #or the like, conventional procedural programming languages, such as the “C” programming language, and functional programming languages such as Python, Hotlab, Prolog and Lisp, machine code, assembler or any other suitable programming languages.

Also shown in FIG. 1 is the optional data feedback loop between the quantum system 38 and the external support unit 12 provided by the partial quantum data read out. The quantum state is stored in the qubits of the one or more quantum cores 60. The detectors 62 function to measure/collapse/detect some of the qubits and provide a measured signal through appropriate buffering via CDS 70 to the output ADC block 74. The resulting digitized signal is sent to the decision logic block 16 of the external support unit 12 which functions to reinject the read out data back into the quantum state through the high speed interface 58 and quantum initialization circuits. In an alternative embodiment, the output of the ADC is fed back to the input of the QPU.

In one embodiment, the quantum core comprises quantum dots that exhibit a quantum effect, is capable of forming entangled states, and is capable of performing energy optimization. Ultimately, the minimum energy quantum state is read out of the quantum core and used in subsequent processing.

In one embodiment, quantum error correction (QEC) is performed via QEC block 64 to ensure no errors corrupt the read out data that is reinjected into the overall quantum state. Errors may occur in quantum circuits due to noise or inaccuracies similarly to classic circuits. Periodic partial reading of the quantum state function to refresh all the qubits in time such that they maintain their accuracy for relatively long time intervals and allow the complex computations required by a quantum computing machine.

It is appreciated that the architecture disclosed herein can be implemented in numerous types of quantum computing machines. Examples include semiconductor quantum computers, superconducting quantum computers, magnetic resonance quantum computers, optical quantum computers, etc. Further, the qubits used by the quantum computers can have any nature, including charge qubits, spin qubits, hybrid spin-charge qubits, etc.

In one embodiment, the quantum structure disclosed herein is operative to process a single particle at a time. In this case, the particle can be in a state of quantum superposition, i.e. distributed between two or more locations or charge qdots. In an alternative embodiment, the quantum structure processes two or more particles at the same time that have related spins. In such a structure, the entanglement between two or more particles could be realized. Complex quantum computations can be realized with such a quantum interaction gate/structure or circuit.

In alternative embodiments, the quantum structure processes (1) two or more particles at the same time having opposite spin, or (2) two or more particles having opposite spins but in different or alternate operation cycles at different times. In the latter embodiment, detection is performed for each spin type separately.

Note that in one embodiment the quantum system 38 is fabricated on a single chip and comprises quantum cores 60 and a classical controller comprising a plurality of driver circuits, detector circuits, and complementary metal oxide semiconductor (CMOS) processor. The quantum system is typically in communication with another classical processor for administration, configuration, and control.

As an example of advanced CMOS, the 22 nm FDSOI process is capable of providing scalability of qubits. Similar to an integrated circuit (IC) chip, where a single nanometer-scale CMOS transistor can be reliably replicated billions of times to build a large digital processor, a position-based charge qubit structure, a spin-based qubit structure, or a hybrid thereof which can be realized as a CMOS compatible coupled quantum system (e.g., quantum dot array (QDA)) in a way that satisfies the manufacturer's design rule check (DRC) with possible minor exceptions signed off by process engineers. The qubit structure is replicated thousands or millions of times to construct a single chip quantum processor operating at 4 K where the cooling requirements are modest.

In one embodiment, the quantum system combines the best features of charge (i.e. high-speed operation) and spin (i.e. long coherence times) qubits in a so called hybrid qubit. Such a hybrid qubit can be controlled electrically without the need for microwave pulses but it requires a solid magnet of 0.5-1 T which can be added to a 4 K cryo chamber. The control and detection of quantum spin states can be based on utilizing the Pauli exclusion principle which dictates that two electrons of the same spin cannot occupy the same quantum dot. The required movement of electrons between quantum dots to try to force them into one quantum dot and the subsequent position detection constitutes the part of charge qubit.

Note that the 22 nm FDSOI process has unique benefits for quantum operation. In contrast to bulk CMOS, FDSOI provides a thin semiconductor layer isolated vertically from the substrate by a 20 nm buried oxide (BOX) layer. Therefore, a quantum particle can be strictly confined inside the 5 nm thin semiconductor film where it precisely follows the gate control and is isolated from the substrate impurities to further increase its decoherence time.

In one embodiment, quantum dots are nanoscopic in size. They are constructed in CMOS using the minimum dimensions that the fabrication process allows. They are small enough to accommodate a single quantum particle, i.e. electron or hole, to hold the quantum information either in its magnetic spin (up or down) or position (being present or absent in a given quantum dot). Note that the underlying principle of quantum dot is a Coulomb blockade by exerting a repulsive force preventing other electrons from joining in and occupying the same space. The key parameter is its capacitance to the background. For a quantum dot of small enough capacitance C, a single electron of charge e entering will decrease the electric voltage potential by observable, while presenting the energy barrier of. For example, an island of a 20 aF capacitance, which can be readily created in CMOS by resorting to a minimum size of the diffusion area, exhibits the single electron charging energy of 4 meV. It is an order of magnitude greater than the thermal energy kT=0.36 meV at T=4.2 K, where k is Boltzmann's constant. This prevents thermally excited electrons from tunneling into the island.

### Quantum Operation

To aid in understanding the principles of the present invention, a brief explanation of quantum operation is presented below.

As stated supra, in classic electronics, the unit of information is a bit that can represent only one of the two states “0” and “1” at a given time. Computations in classical computers are performed sequentially and every bit can hold only one state at a time.

As stated supra, quantum electronics uses the quantum behavior of particles to perform computations. The unit of quantum information is a quantum bit or qubit. A qubit has two base states denoted by \hat{0} and \hat{1} (or |0> and |1>) (a qudit can have additional states) but in contrast with a classic bit, a qubit can be in a superposed state that contains some percentage (complex-valued amplitude ‘a’) of state \hat{0}, and some percentage (complex-valued amplitude ‘b’) of state \hat{1} denoted by a state a\hat{0}+b\hat{1}. Since a qubit in quantum structures can simultaneously be in multiple superposed states, multiple sets of computations can be performed concurrently, resulting in large quantum computation speed-ups, when compared with classic computations.

A quantum particle is described by its position and/or spin. The particles used in quantum structures are called quantum particles. There are qubits based on the quantum position of the particles, also named charge-qubits, while other qubits use the spin of the quantum particles, also named spin-qubits. In quantum structures, the charge carriers are held in specific regions called quantum dots or qdots. A quantum structure is constructed from one or more qdots.

Performing a quantum computation involves several steps. First the structure needs to be reset, which means that all the free carriers (e.g., electrons or holes) from the structure need to be flushed out. Once the free carriers are removed, the structure is initialized meaning particles are introduced in one of the base states (e.g., \hat{0} or \hat{1}). In the case of a charge-qubit (position-qubit) it means that a carrier is loaded in one of the qdots. A free carrier not coming from the quantum initialization process can interact with the quantum particles and result in decoherence, i.e. loss of quantum information. After the particles have been loaded in the corresponding base states they undergo the desired quantum operation under control of gate control terminals. Once the desired quantum operations are complete, a detection is performed whereby the presence or absence of a particle in a given qdot at a given time is tested. Detection is usually destructive which means that the quantum particle's wavefunction and its state collapse. Special nondestructive detection/measurement exist that do not collapse the quantum state. In such cases, multiple measurements of the same quantum state can be performed.

The position of a quantum particle is given by the region where the particle wavefunction is mostly present. In one embodiment, quantum structures use semiconductor qdots realized with semiconductor wells where the particle transport is done through tunneling which is a quantum effect. The tunneling or particle transport is controlled by control terminals. In one embodiment, the control terminals are realized using gates but they may comprise other semiconductor process layers.

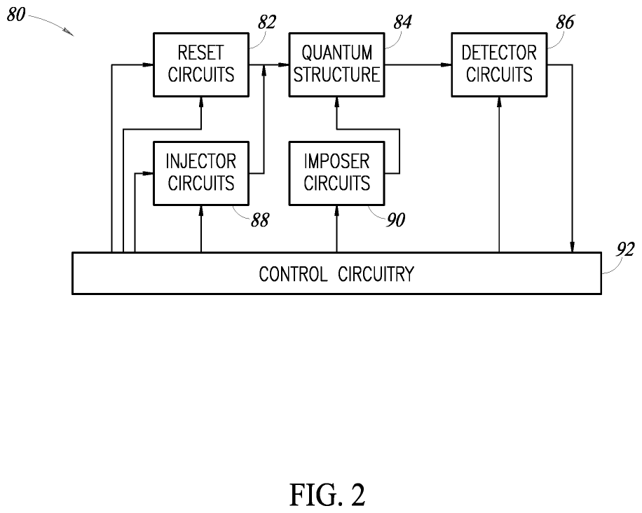

A high level block diagram illustrating a generalized quantum structure interfaced to classical integrated electronic control circuitry is shown in FIG. 2. The example quantum circuit, generally referenced 80, comprises quantum structure 84 at its core, and support circuitry that in one embodiment is integrated on the same physical realized support or external on a different physical realized support. The support circuitry comprises reset circuits 82 for flushing the quantum structure of any available free carriers before starting the quantum operation and to prepare it for a new quantum operation, injector circuits 88 that function to inject one or more particles into the quantum core structure, imposer circuits 90 that control the quantum operation and the flow of the quantum computation between the injected particles, detector circuits 86 that sense whether a particle is present or not in the output qdots and the particles at the output points of the quantum structure after the quantum operation has been performed, and control circuitry 92. Note that in one embodiment, multiple such quantum structures/quantum cores can be interconnected and/or operated in parallel. Further note that the common electrical node of the reset circuit 82 output and the injector circuit 88 output can be the same as the electrical node of the detector circuit (86) input. In this case, the three circuits time-share their active operations.

To achieve quantum operation, physical structures must be cooled to cryogenic temperatures and be isolated as much as possible from environmental perturbations (e.g., external electric fields and/or magnetic fields, etc.). To perform quantum computing using particles in a semiconductor structure, the particles (e.g., electrons, holes, etc.) need to be able to be excited in quantum states and to stay in such states for a long enough time for the operation and measurement of the quantum operation to be realized. At higher temperatures, the thermal energy of the particle results in the decoherence of its quantum state.

In one embodiment, the semiconductor based quantum structure uses a continuous well with an imposing gate that generates a controlled local depletion region to separate two or more regions of the well that form quantum dots (qdots). By modulating the potential of the imposer gate, controlled tunneling through the local depleted region is enabled between the plurality of sections of the continuous well, realizing the function of a position/charge qubit. It is appreciated that more complex structures having a higher number of qdots per continuous well and a larger number of wells can be built using the techniques of the present invention. Both planar and 3D semiconductor processes can be used to build such well-to-well tunneling quantum structures. By combining a number of such elementary quantum structures/gates, a quantum computing machine is realized.

### Quantum Error Correction (QEC) Using Machine Learning

Distributing information across a large number of qubits in a qubit array requires error detection and correction to address errors that occur in the array. When an error, which is inevitable, is detected, the present invention provides a mechanism for correcting the errors. The information in the array is not lost due to an error in any individual qubit entering an error state.

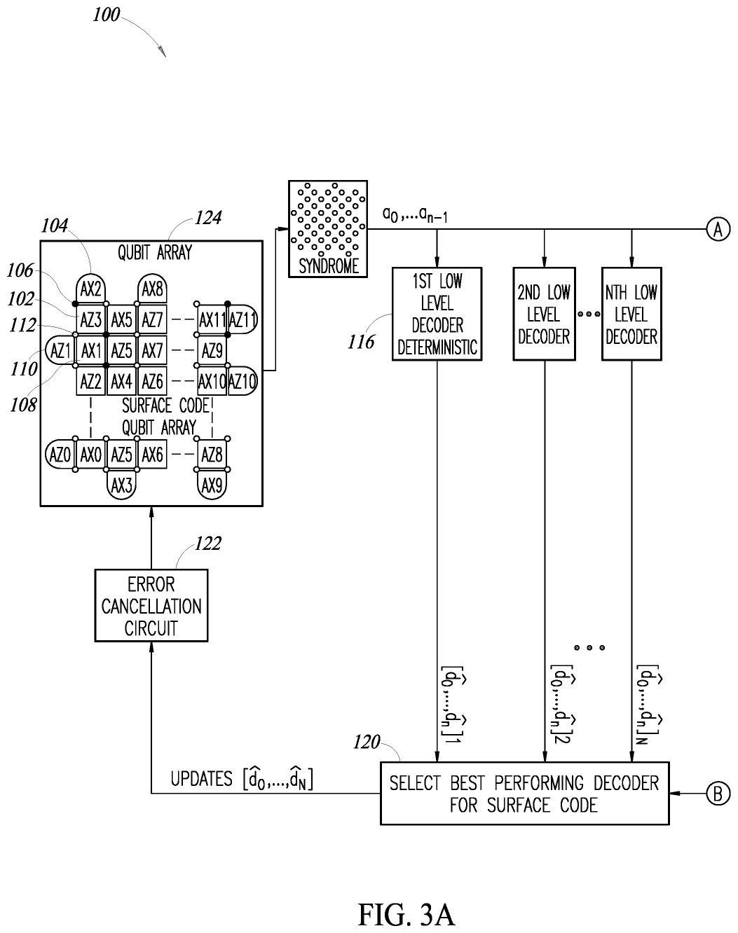

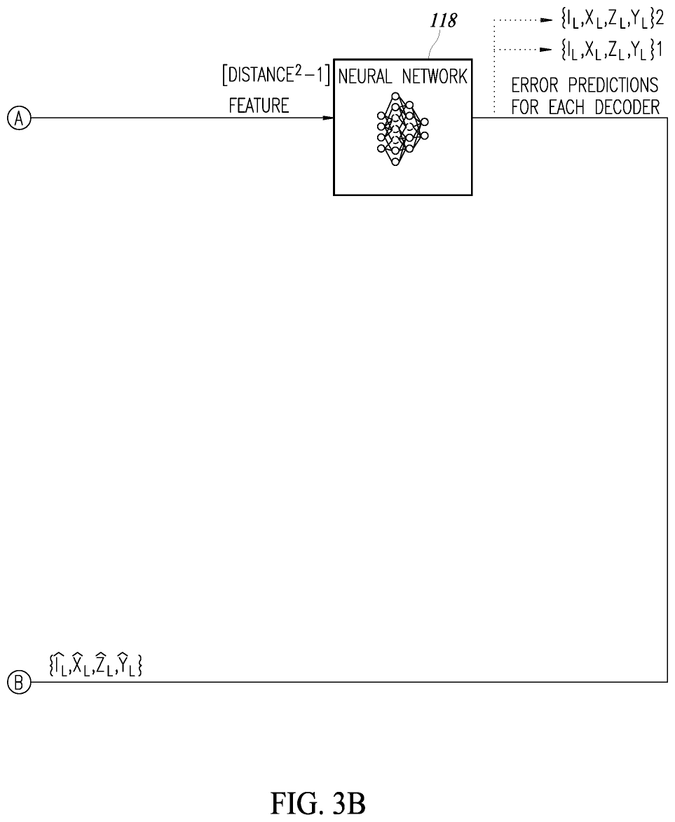

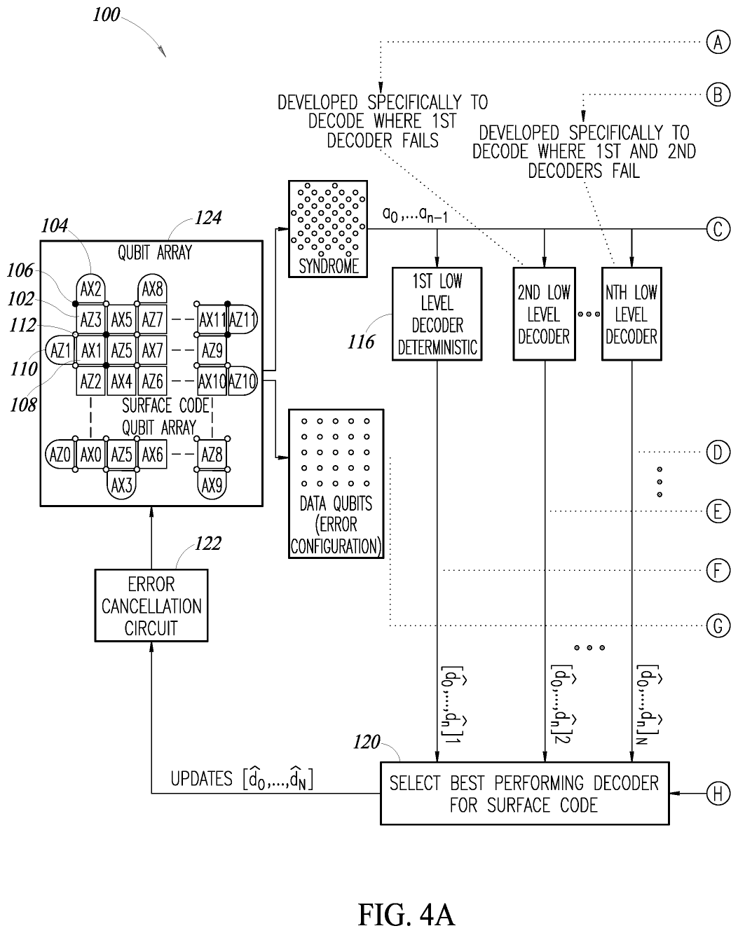

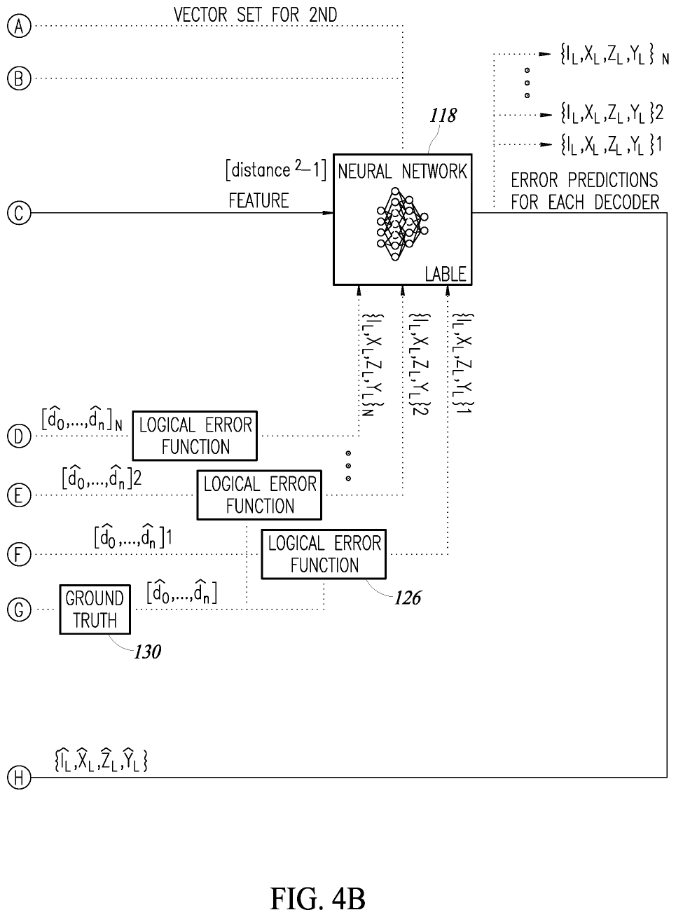

A diagram illustrating an example machine learning assisted quantum error correction circuit with multiple decoders is shown in FIGS. 3A and 3B. A diagram illustrating an example machine learning assisted quantum error correction circuit with multiple decoders during training is shown in FIGS. 4A and 4B. With reference to FIGS. 3A, 3B and 4A, 4B, the quantum system, generally referenced 100, comprises a qubit array 124 incorporating an encoding arrangement such as a two dimensional surface code that includes data qubits 112, data qubits with errors 106, 2-way entangled ancilla X-basis 104, 2-way entangled ancilla Z-basis 110, 4-way entangled ancilla X-basis 108, and 4-way entangled ancilla Z-basis 102. In one embodiment, the qubit array can be considered a memory array with data distributed across states in the array like a surface code over a qubit array, such as a two dimensional array.

It is appreciated that the surface code qubit array 124 shown in FIGS. 3A, 3B and 4A and 4B is for illustration purposes only and that the mechanism of the present invention can be used with any qubit array with any desired surface code and type of qubit (e.g., charge, spin, photonic, trapped ion, etc.) which are not critical to the invention.

Typically, one of the problems the exists in a quantum array is that the quantum state cannot be measured without destroying or collapsing the state of that qubit. To get around that, ancilla bits are used which are an entangled state of the qubit which can be measured without destroying the data qubit itself. Ancilla bits a₀, . . . , aₙ₋₁ output of syndrome block 114 are used to help measure the state of the data qubit but not to preserve its state.

An array of ancilla qubits is constructed in such a way as to provide a parity measurement of the data qubits reflecting the current state of the data qubits without collapsing that state on measurement.

Multiple ancilla measurements along either vertical or horizontal axis make up the syndrome pattern, which can be subsequently decoded to identify the probability of a data qubit error. The output of the decoders is fed back to the qubit array via the error cancellation circuit 122. A certain amount of information can be detected in terms of which data qubits are in an error state having been bit flipped, phase flipped, or both, and which qubits are not in error. Detecting which data qubits are in error and correcting them allows the preservation of the overall state of the quantum array for a longer time referred to as logical state. In essence, a feedback loop is established, and errors are detected as soon as they arise and then an adjustment is made to cancel out those errors such that the logical state is maintained.

In implementing a higher level of encoding, one ancilla is used in turn to parity check (i.e. detect) for multiple (e.g., four) nearest neighbors' data qubits. This allows for better detection and correction of the faulty qubits.

The two dimensional sphere sequence allows you to detect where there were direct errors. A pattern is generated that is used to correct the qubits in error. The errors in the ancillas from the syndromes 114 are detected and a plurality of decoders 116 are used to correct those ancillas. The output of the decoders is fed back to the qubit array via the error cancellation circuit 122. The output of the decoders is a vector of the same number of bits to be optimized.

Note that the use of a single low latency decoder 116 can be problematic since different errors produce similar syndrome patterns with varying degrees of probability. A second decoder can be employed specifically to resolve the syndrome patterns that the first decoder cannot determine with high certainty. This concept is extended to N^{th} level decoders until an acceptable criteria of error detection is reached.

Multiple decoders are utilized where each decoder is adapted to address a specific error scenario. The decoders 116 are referred to as low-level decoders or pure error decoders but they do not always correct properly. The decoders operate by looking at the ancillas in the syndromes 114. They process the ancilla qubits that yields the syndromes which is a one dimensional pattern indicating the error similar to a parity check. The decoder functions to generate a correction sequence to correct and/or to identify which of the data qubits is actually in error and then flip those qubits. The syndrome 114 is effectively a string of parity bits that provides information about where the error is in the surface code. Since the code used in the array is a surface code and the array can be relatively large, e.g., fifty or more qubits, the syndrome may very wide. It is advantageous to have a wide syndrome because the larger the information is spread across the qubits, the better the protection for consecutive errors.

For example, considering an array of three qubits, the data could only be spread out between three qubits. Although it would be possible to detect one error, it would not be possible to determine which qubit the error occurred in. The wider the syndrome, the better able the error can be corrected after its occurrence.

In operation, the decoders function to measure the long syndromes, or sequences of ancillas measurements (i.e. parity bits) which is called a syndrome. For example, consider the ancilla measures four qubits and returns a parity measurement for those four qubits. A sequence of the ancilla measurements forms a syndrome. The syndrome is input to an array of a low latency decoders in parallel which generate correction instructions as to which data qubits need to be corrected to preserve the logical qubit state of the array.

The plurality of decoders provides a practical approach under the supervision of a trainable neural network to determine which (if any) of the decoder outputs are to be used to determine highest probability of error cancelation. Note that it may be that none of the decoder outputs are correct. The decoders are configured such that each successive decoder address specific deficiencies of the previous decoder. Thus, syndromes with multiple error contributors can be accommodated using additional decoders.

All the decoders read in syndromes which are arrays or sequences of ones and zeros. Often, however, multiple errors may yield the same syndrome, not unlike a classical CRC circuit. For example, there may be two different errors in the qubit array that are completely unrelated that will generate the same syndrome. This can be addressed using software which typically takes too long to be practical. Another way this can be addressed is to use sophisticated hierarchical hardware with the disadvantage of consuming large amounts of power making it unsuitable for quantum environments. A third approach as taught herein is to decode the syndrome output at multiple levels or planes using multiple decoders based on classical combinatorial logic circuits, each dedicated to a unique level or plane.

There are times where the output from a single decoder is incorrect. The logical error rate is the rate at which a wrong error correction is generated. All the information distributed across the qubit array of the surface code qubit array represents one logical qubit state for spin and one logical state for phase. The system tries to correct logical errors that occur but the logical errors actually are not known because it is embodied in the data qubits. The only time an error actually known is when the data qubits are measured and the quantum state collapses. This, however, is not useful because whether an error actually exists is not known. Therefore, the present invention predicts what the logical error rate is going to be. One way to perform this prediction is to build a neural network model and use machine learning to generate the prediction.

During a training mode of operation the neural network model identifies which decoder has the highest probability of detecting the exact error from the syndromes. The decoders function to look only at the syndromes and each decoder predicts how good and what changes to make to improve the surface code or to correct the errors in the surface code. The neural network model is trained because sometimes one or more of the decoders will be wrong. For example, in the case where two different errors yields the same syndrome. Thus, sometimes the decoder outputs will be incorrect. Having access to the data qubits themselves allows the system to determine which of those syndromes is likely to present a problem.

The invention thus provides a model that can be trained to look at the data qubits and be able to predict which decoder will yield the optimal output pattern. The decoder output patterns are compared to what the actual data should be from the model thus providing a logical error rate prediction. During training, the output of each decoder 116 is input to a corresponding logical error function 126. Each logical error function block generates an error prediction of the actual error in the data qubits. This provides the labels for training the neural network 118.

Although the data qubits cannot actually be measured, the output of the syndromes can be measured. The syndromes that are output from the ancilla bits are passed through the neural network. The data qubits 115 are the ground truth 130 which are compared to the decoder outputs to predict which of the data qubits are actually in error. The logical error function performs this comparison whose output indicates which one of the decoder outputs causes an error, i.e. which decoders right which are wrong. The model 118 of the data qubits is employed because the data qubits cannot actually be measured without destroying them. The model is used to predict how accurate the outputs of the low level decoders are. Data qubits can be measured using quantum swaps with the ancilla qubits during off-cycle training.

Since the system must correct qubit errors within the decoherence time of the qubit, each low-level decoder is preferably relatively simple. It is configured to have relatively low latency for the inference cycle. The second, third, . . . , N^{th} low-level decoders are specifically designed such that they do not repeat the same error code. The second decoder does not generate the errors that the first low level decoder generates, the third decoder does not generate the errors that the second low level decoder generates, and so on. The additional decoders only operate on the syndrome codes that the primary low level decoder introduces for the logical error. The machine learning block is then used to predict which one of the decoders to use in order not to introduce any logical error. Thus, the machine learning block 118 functions to determine which one of these decoders to use which will correct the faulty data qubit errors.

To determine the configuration of the first decoder, the output is fed into a corresponding logical error function 126 along with the ground truth 130. The logical error function block indicates whether the decoder will produce an error, i.e. whether its error correction is incorrect. If a decoder error is expected, the second low level decoder is introduced and configured to produce a different prediction for the same input ancilla bits. Thus, all decoders use the same ancilla bits as input but they generate a different prediction on how to direct those bits. The second decoder is designed specifically for the syndrome codes that the first decoder will incorrectly decode. In the event that both the first and the second decoders choose incorrect error correction, a third decoder would be selected, and this can be extended to an N^{th} decoder.

Note that ground truth 130 indicates the real state of the data qubits from a model point of view. The ground state is what is used to determine whether a logical error occurred. Thus, by comparing the ground truth with the output of each of the decoders, it can be determined during a machine learning step whether a logical error occurred. If a logical error in an error decoder output is detected, then it is known that for a specific syndrome the output of the decoder should not be selected for correcting the array. This label information is used to train the model. The dotted lines in FIGS. 4A and 4B indicate use during training mode of operation.

FIGS. 3A and 3B represent the system during inference mode of operation in which one of the decoder outputs is selected via decoder selection block 120. The decoder pattern to be used in the qubit array 124 is selected and input to the error cancellation circuit 122 which functions to generate the actual qubit correction updates to the array 124 from the selected decoder output pattern. Thus, the system forms a feedback path for detecting and correcting qubit errors in the array.

Note that it is possible that none of the decoders have the right error correction. In this case, additional low level decoders can be added to the feedback loop in order to produce the correct error correction output. The neural network assists the error correction by determining which of the syndromes are likely to cause a problem. This information is used to select which of the decoders output to use for error correction in the array to help make the surface code error fault tolerant.

It is also noted that the error correction feedback loop must operate and correct errors in the qubit array within the coherency time of the qubits. Thus, the decoding and machine learning inference as well as the updates to the qubits all must happen within the decoherence time of the qubit. Having the classical control logic reside in the same integrated circuit as the qubit array enables qubit correction before the decoherence time expires.

The plurality of decoders includes individual combinatorial logic based decoders each configured or trained to address a certain sequence or type of error encountered in the qubit array. Preferably, the decoders are ‘orthogonal’ to each other meaning they look for different non-overlapping sequences or they are trained or designed to look at the decoding problem differently from each other. For example, one decoder can be configured to detect spin qubit errors. A second decoder may be configured to detect bit flip qubit errors. A third decoder may be configured to detect a combination of spin and bit flip errors. In this case, each of the decoders is optimized to look at each of these different decoding problems. Having multiple decoders improves system performance by increasing the probability of detecting errors. This provides much better odds of detecting an error. If individual qubit errors can be detected, then action can be taken to mitigate this errors.

Regarding the neural network 118, the dimension of the features input to the network is distance squared minus one which indicates the number of qubits input to the neural network. The neural network also receives associated labels during a training mode of operation. This is the input to the neural network which is trained to match labels with the distance. The output of the neural network are error predictions for each decoder (i.e. a four bit code) that are used to select one of the decoder outputs.

In one embodiment, the output of the neural network comprises an error vector {Î_{L}, \hat{X}_{L}, \hat{Z}_{L}, Ŷ_{L}} containing an error prediction for each of the decoders. Î_{L} is the quantum identity case which means takes no action as there is no error to be corrected. \hat{X}_{L} represents that a logical bit flip or spin error occurred and needs to be corrected, i.e. the prediction of the bit flip that is then translated into how to update the qubit array to implement the correction. \hat{Z}_{L} represents the presence of a phase flip error in a qubit which indicates the phase angle needs to be corrected. Ŷ_{L} indicates that there is both a bit (i.e. spin) flip as well as a phase angle error that needs to be corrected.

Thus, the output of the neural network functions to indicate which of the possible errors are needed to be corrected. The decoder selection block 120 functions to choose the best performing decoder for the particular surface code used in the qubit array.

The error cancelation circuit 122 functions to generate the n-dimensional update comprising instructions how to fix the errors that are applied to the qubit array 124. The update incorporates how to alter the spins, phase angles, etc. of the qubits in the array based on the output of one of the decoders. The neural network 118 operates in inference mode to generate error predictions for each decoder.

During offline supervised training, the neural network receives outputs of logical error function circuits 126 which generate the low level decoder errors that are used to train the neural network 118. The outputs of the N decoders 116 are input to the logical error function blocks 126. During offline training measurements of the qubit array are taken and the data qubits (error configuration) 115 are the measurements to be error checked. It can be predicted what the output of the decoders would be based on the data qubits since the logic of the decoders is deterministic. The weights of the neural network are thus trained offline using actual data from the qubit array.

In operation, each one of the low level decoders generates a pattern in parallel from the same syndrome code that indicates where one or more errors are located. This increases the likelihood of identifying the qubit in error. Each decoder, however, generates a different pattern depending on where it determines an error is. All N decoders generate a suggestion to fix the errors. Machine learning is used to select the decoder with the highest probability of being correct. The neural network which also receives the syndrome data determines a suggestion as to which of the N decoders is likely to be the most correct one to use. In other words, neural network determines the most likely place the error has occurred. The neural net is trained to output which one of the decoders is correct. The decoder selection circuit 120 which may comprise classical multiplexer logic functions to select one of the N decoders and the output thereof is input to the error cancellation circuit 122 which in one embodiment comprises a state machine. Updates to the qubits are generated and applied to the qubit array 124. Thus, the mechanism of the present invention provides fault tolerance to the qubit array by detecting and canceling errors in the array.

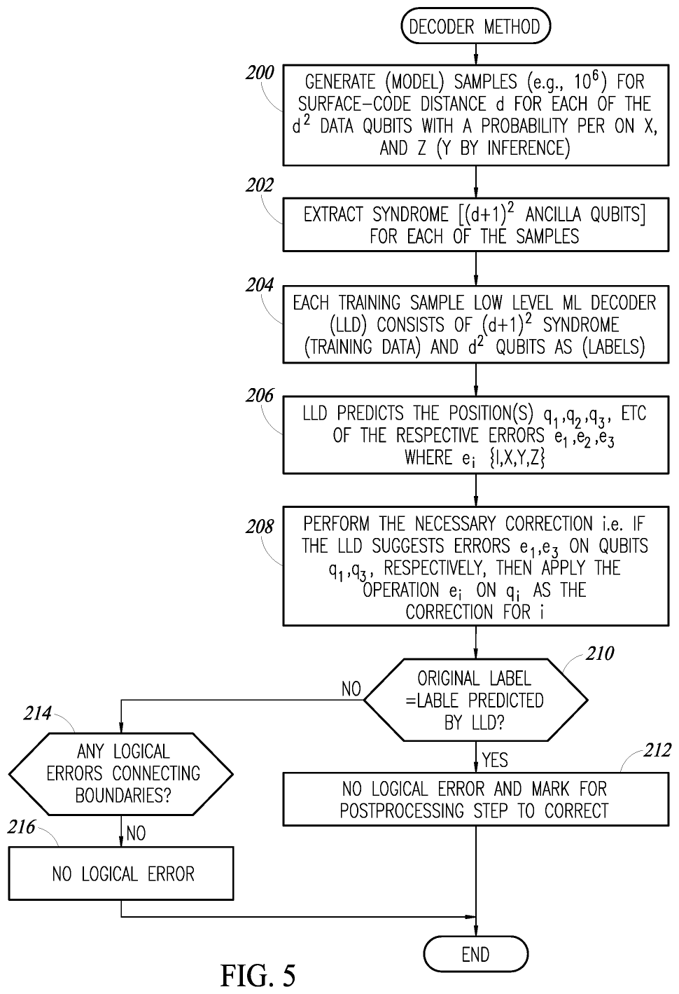

A diagram illustrating an example decoder method is shown in FIG. 5. First, a plurality of samples are generated, e.g., 10⁶ samples, for surface code distance d for each of the d² data qubits with a probability PER on X, and Z (Y by inference X*Z) (step 200). Syndromes (in the example of surface codes, (d)²−1 ancilla qubits) are extracted for each of the 10⁶ samples (step 202). For each training sample the low-level ML decoder (LLD) consists of (d)²−1 syndrome (training data) and d² qubits as labels (step 204). Each training sample for high level decoder (HLD) consists of (d)²−1 syndromes which are the features for the neural network (NN) and one of the three Pauli Logical Errors {I, X, Y, Z} or identity I which is the label. The LLD predicts the position(s) q₁, q₂, q₃, . . . of the respective errors e₁, e₂, e₃, . . . where eᵢ{I, X, Y, Z} (step 206). The necessary correction is then performed i.e. if the LLD suggests errors e₁, e₃ on qubits q₁, q₃, respectively, then apply the operation eᵢ on qᵢ as the correction for i (step 208). It is then checked whether the original label is equal to the label predicted by the LLD (step 210). If it is equal, then no logical error is found and it is marked for a postprocessing step to correct (step 212). Otherwise, it is checked whether there are any logical errors connecting boundaries (step 214). If there are no logical errors, then no logical error is declared (step 216).

A recognized disadvantage of very low latency low level decoders is that they can introduce logical errors since they do not consider the complete picture of the surface code. The introduction of the errors by these decoders can be predicted using a ML algorithm. By providing multiple decoders, i.e. second, third, etc. the mechanism can handle faults introduced by the decoders. Additional low level decoders (LLDs) are specifically configured to operate on those syndrome codes that cause the primary LLD to introduce logical errors. ML is used to predict which decoder to use to avoid introducing logical errors.

It is appreciated that one skilled in the art can combine the above described embodiments, methods, and techniques in any desired combination to create additional systems. Those skilled in the art will recognize that the boundaries between logic and circuit blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediary components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the claims, any reference signs placed between parentheses shall not be construed as limiting the claim. The use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first,” “second,” etc. are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of error detection and correction in a quantum computing system, the method comprising:
providing a qubit array having an encoding arrangement and a plurality of ancilla bits;
extracting a plurality of syndrome codes from said plurality of ancilla bits;
providing a plurality of low level decoders that operate in parallel on said plurality of syndrome codes; and
utilizing a neural network to predict which of said plurality of low level decoders to use to minimize introducing logical errors in said qubit array.

2. The method according to claim 1, wherein a low level decoder is selected to ensure error correction occurs within a decoherence time of qubits in said qubit array, thereby preserving quantum information integrity.

3. The method according to claim 1, wherein said plurality of low level decoders are configured to address specific qubit error scenarios.

4. The method according to claim 1, wherein said neural network analyzes patterns in said plurality of syndrome codes to determine an optimal decoder for qubit error correction.

5. The method according to claim 1, further comprising:
providing training data to said neural network comprising syndromes obtained from ancilla measurements and corresponding error correction outcomes; and
training said neural network using said training data to identify patterns in syndromes and predict optimal error correction strategies.

6. The method according to claim 5, wherein said training data comprises syndromes obtained from ancilla measurements and corresponding error correction outcomes obtained from a known error-free qubit array.

7. A method for error detection and correction in a quantum computing system, the method comprising:
receiving a plurality of syndromes from a qubit array having ancilla qubits;
analyzing via a plurality of decoders said plurality of syndromes obtained from ancilla measurements to identify errors and propose corrections whereby each decoder independently and in parallel utilizes a different decoding strategy to propose respective qubit corrections;
selecting a decoding strategy based on machine learning predictions; and
correcting detected errors using the selected decoding strategy.

8. The method according to claim 7, wherein a low level decoder is selected to ensure error correction occurs within a decoherence time of qubits in said qubit array, thereby preserving quantum information integrity.

9. The method according to claim 7, wherein said plurality of low level decoders are configured to address specific qubit error scenarios.

10. The method according to claim 7, wherein said neural network analyzes patterns in said plurality of syndrome codes to determine an optimal decoder for qubit error correction.

11. The method according to claim 7, further comprising:
providing training data to said neural network comprising syndromes obtained from ancilla measurements and corresponding error correction outcomes; and
training said neural network using said training data to identify patterns in syndromes and predict optimal error correction strategies.

12. The method according to claim 11, wherein said training data comprises syndromes obtained from ancilla measurements and corresponding error correction outcomes obtained from a known error-free qubit array.

13. A system for error detection and correction in a quantum computing system, comprising:
a quantum processing unit (QPU) comprising a two-dimensional encoding arrangement qubit array;
a plurality of ancilla qubits for generating syndrome codes;
a plurality of low level decoders operating in parallel on said syndrome codes to generate candidate qubit error correction vectors;
a neural network trained to predict qubit errors and an optimal decoding strategy based on syndromes obtained from ancilla measurements; and
a selector operative to choose one of said candidate qubit error correction vectors based on said optimal decoding strategy.

14. The system according to claim 13, wherein latency of said plurality of low level decoders ensures error correction occurs within a decoherence time of qubits in said qubit array, thereby preserving quantum information integrity.

15. The system according to claim 13, wherein said plurality of low level decoders are configured to address specific qubit error scenarios.

16. The system according to claim 13, wherein said neural network analyzes patterns in said plurality of syndrome codes to determine an optimal decoder for qubit error correction.

17. The system according to claim 13, wherein
said neural network is provided training data comprising syndromes obtained from ancilla measurements and corresponding error correction outcomes; and
said neural network is trained using said training data to identify patterns in syndromes and predict optimal error correction strategies.

18. The system according to claim 17, wherein said training data comprises syndromes obtained from ancilla measurements and corresponding error correction outcomes obtained from a known error-free qubit array.
